(19) United States
(12) Patent Application Publication
(10) Pub. No.: US 2014/0202558 A1
(43) Pub. Date: Jul. 24, 2014

(54) VALVE MANIFOLD BOX

(71) Applicants: TAIWAN PURITIC CORP., Hsinchu County 303 (TW); MEGAFLOW CORP., Taipei City 116 (TW)

(72) Inventors: CHIH-HSIEN CHOU, HSINCHU COUNTY 303 (TW); CHUNG-HSIU YEH, HSINCHU COUNTY 303 (TW); ANTHONY KAI TAI CHAN, HSINCHU COUNTY 303 (TW)

(73) Assignees: MEGAFLOW CORP., TAIPEI CITY (TW); TAIWAN PURITIC CORP., HSINCHU COUNTY (TW)

(21) Appl. No.: 13/751,305

(22) Filed: Jan. 28, 2013

(30) Foreign Application Priority Data
Jan. 18, 2013 (TW) 102201139

(51) Int. Cl. F16K 27/12

(52) U.S. Cl. CPC F16K 27/12
USPC 137/377

(57) ABSTRACT

A valve manifold box comprises a chamber and a front cover. Significantly, the chamber is manufactured by injection molding and is one-piece construction. Moreover, the chamber comprises a back board, a sidewall, at least an outfall, and multiple fittings and inside surface at the bottom sidewall has changes in an inclination angle for collecting the liquid within the chamber. By means of injection molding, one piece construction of the chamber is obtained such that it prevents chemicals from leaking outside. Besides, by using the design that the inside surface at the bottom sidewall has changes in an inclination angle, liquid can be easily collected and drained. Also, since it is unnecessary to frequently maintain the valve manifold box, maintenance costs are saved.

### BACKGROUND OF THE INVENTION

1. Field of the Invention

The present invention relates to a valve manifold box, and more particularly to a valve manifold box for conveying chemicals.

2. Description of the Prior Art

For semiconductor industry or electronic industry, chemicals such as acids or alkalis are usually used for etching, cleaning, surface modification, etc. Thus, chemical supply systems must be established in factories to supply different species of chemicals in desired flow rate through pipelines to equipments during manufacturing processes. Generally, chemical supply systems comprise valve manifold boxes in the factory to convey chemicals. However, after long term use of pipelines in valve manifold boxes, chemicals leakage happens. Because valve manifold boxes are assembled by welding or screwing multiple pieces of sheets together, it may cause seams or gaps at the junction between the plates. A common situation is that chemicals leakage from the pipelines into the valve manifold box leak through the corners of the valve box and contaminates equipments and workplaces. As a result, it causes process failure and affects industrial safety.

Thus, finding a solution to leaking problems of chemicals in valve manifold boxes is the current target.

### SUMMARY OF THE INVENTION

The present invention is directed to a valve manifold box, and particularly, a valve manifold box for conveying chemicals. By means of injection molding, one piece construction of the chamber is obtained such that it prevents chemicals from leaking outside. Besides, by using the design that the inside surface at the bottom sidewall has changes in an inclination angle, liquid can be easily collected and drained. Moreover, since it is unnecessary to frequently maintain the valve manifold box, maintenance costs are saved.

In one embodiment of the present invention, the proposed valve manifold box comprises a chamber and a front cover. The chamber is manufactured by injection molding and is one-piece construction. The chamber comprises a back board, a sidewall, at least an outfall, and multiple fittings. The sidewall erects from the back board to form a space therein and a front opening opposite to the back board. The space is used for accommodating multiple pneumatic valves and multiple pipelines inside the chamber, and an inside surface at the bottom sidewall has changes in inclination angle for collecting the liquid within the chamber. The outfall is arranged on the bottom sidewall for drawing off the collected liquid. Multiple fittings are arranged on the sidewall of the chamber for connecting the pipelines outside the chamber. The front cover removably attached to the chamber by covering the front opening of the chamber.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIG. 1A is a schematic diagram illustrating the structure of the valve manifold box according one embodiment of the present invention;

FIG. 1B is a schematic diagram illustrating the structure of the chamber of the valve manifold box according to one embodiment of the present invention;

FIG. 2 is a schematic diagram illustrating the structure of the chamber of the valve manifold box according to another embodiment of the present invention;

FIG. 3 is a schematic diagram illustrating the structure of the chamber of the valve manifold box according to another embodiment of the present invention;

FIG. 4A is a schematic diagram illustrating the structure of the chamber of the valve manifold box according another embodiment of the present invention; and

FIG. 4B is a schematic diagram illustrating the structure of the valve manifold box according another embodiment of the present invention.

### DESCRIPTION OF THE PREFERRED EMBODIMENT

The detailed explanation of the present invention is described as follows. The described preferred embodiments are presented for purposes of illustrations and description, and they are not intended to limit the scope of the present invention.

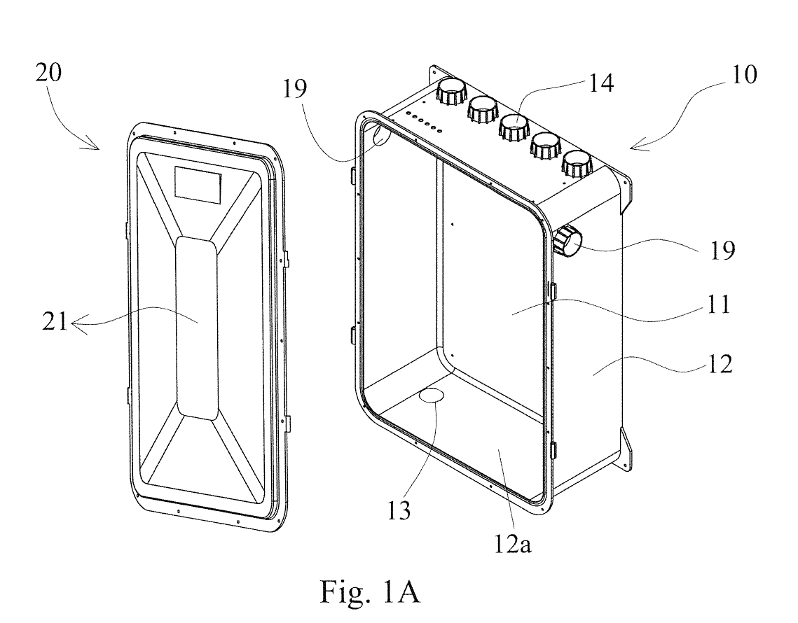

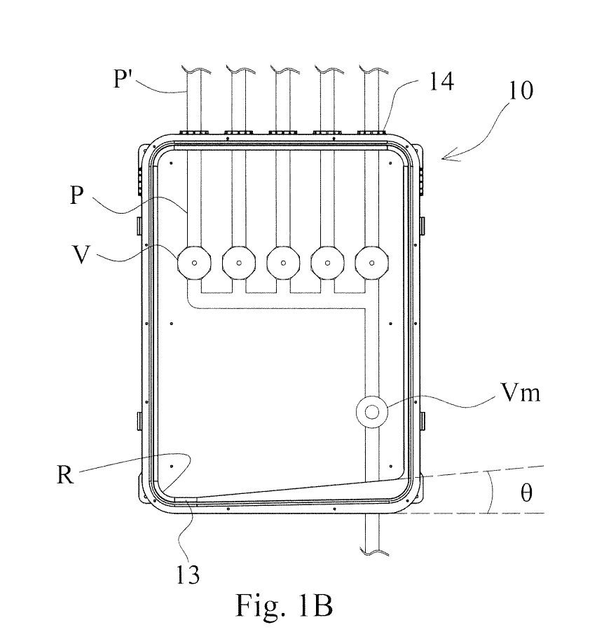

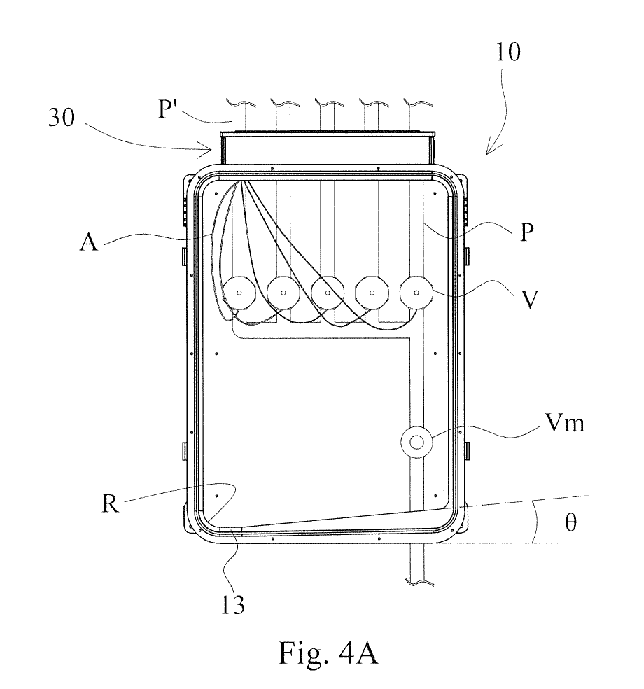

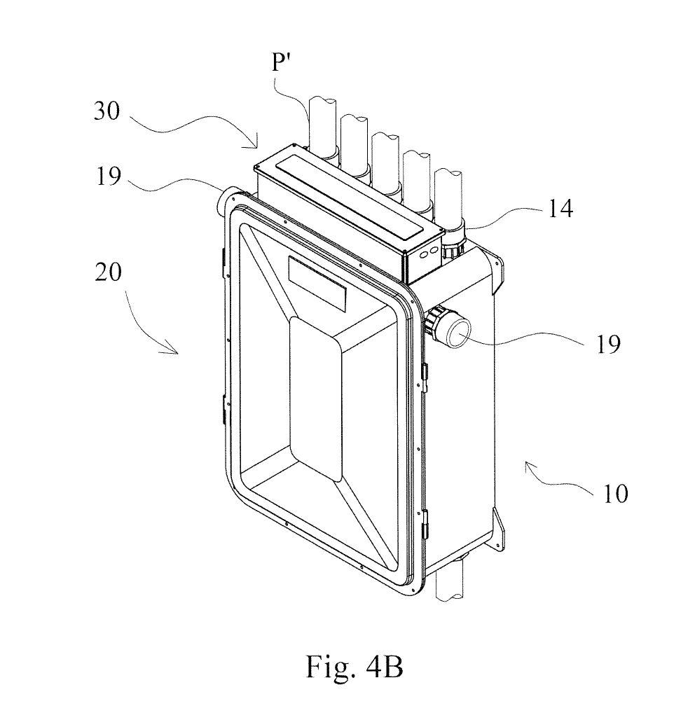

First referring to FIGS. 1A and 1B, in one embodiment of the present invention, the valve manifold box comprises a chamber 10 and a front cover 20. The chamber 10 is manufactured by injection molding and is one-piece construction. The chamber 10 comprises a back board 11, a sidewall 12, at least an outfall 13, and multiple fittings 14. The sidewall 12 erects from the back board 11 to form a space therein and a front opening opposite to the back board 11. The space is used for accommodating multiple pneumatic valves V and multiple pipelines P inside the chamber (as shown in FIG. 1B), and an inside surface at the bottom sidewall 12a has changes in an inclination angle θ for collecting the liquid within the chamber 10. The outfall 13 is arranged on the bottom sidewall 12a for drawing off the collected liquid. Multiple fittings 14 are arranged on the sidewall 12 of the chamber 10 for connecting the pipelines P′ outside the chamber 10. The front cover 20 is removably attached to the chamber 10 by covering the front opening of the chamber 10 (also referring to FIG. 4). It could be understood that the chamber 10 also can include at least a manual valve Vm (as shown in FIG. 1B) to regulate flow of the liquid.

As described above, since the chamber 10 is one-piece construction and not assembled by screwing or welding multiple plates together, there will be no gaps or seams formed between the plates. Chemicals leakage through the corners of the valve manifold box can be prevented.

Comparing to previous design of flat surface inside at the bottom sidewall 12a, according to one embodiment of the present invention, the inside surface at the bottom sidewall 12a has changes in the inclination angle θ it provides a low point near the outfall 13 (as shown in FIG. 1B). Hence, liquid can be easily collected near the outfall 13 due to effect of gravity force acting on the liquid along the inclined surface or curved surface. It facilitates collecting and draining the liquid off. The inclination angle is defined as the angle between the inside surface at the bottom sidewall 12a and the horizontal line. In one embodiment, the inside surface at the bottom sidewall 12a is inclined or curved with changes in the inclination angle θ ranging from 0 to 15 degrees.

Referring to FIG. 1B, in one embodiment, the chamber 10 of the valve manifold box is rectangular cuboid in shape with at least one rounded corner R or one chamfer corner (not shown in the figures) at corners inside the chamber 10 to makes the liquid adhering to the chamber 10 flow downward along the rounded corner 12b or the chamfer corner. Conventionally, the valve manifold box is rectangular cuboid in shape and all angles of corners are right angles. It may let liquid remained at the corners of the chamber 10 especially at the bottom corners of the chamber 10. In contrast, design of rounded corners R or chamfer corners according to one embodiment of the present invention let liquid slip down to be collected and drained through the outfall 13. In one embodiment, the valve manifold box may include four rounded corners R located at the sidewall 12 inside the chamber 10.

Referring to FIG. 1A and FIG. 4, as for the front cover 20 of the valve manifold box, to make it more convenient, the front cover 20 is removably attached to the chamber 10 by using quick release devices (not shown in the figures) such as toggle latches (not shown in the figures). It also can be partly opened or can be removed according to user requirements. For example, it can be partly opened in different directions such as left to right or right to left and also can be flipped up or down. Besides, the front cover 20 may have a curved surface 21 facing the back board 11 to make the liquid adhering to the curved surface 21 slip down. For example, the curved surface 21 can be a concave surface (as shown in FIG. 1B). For the same reason, the curved surface 21 of the front cover 20 is to let liquid slip down due to gravity force acting on the liquid and the liquid will be easily collected.

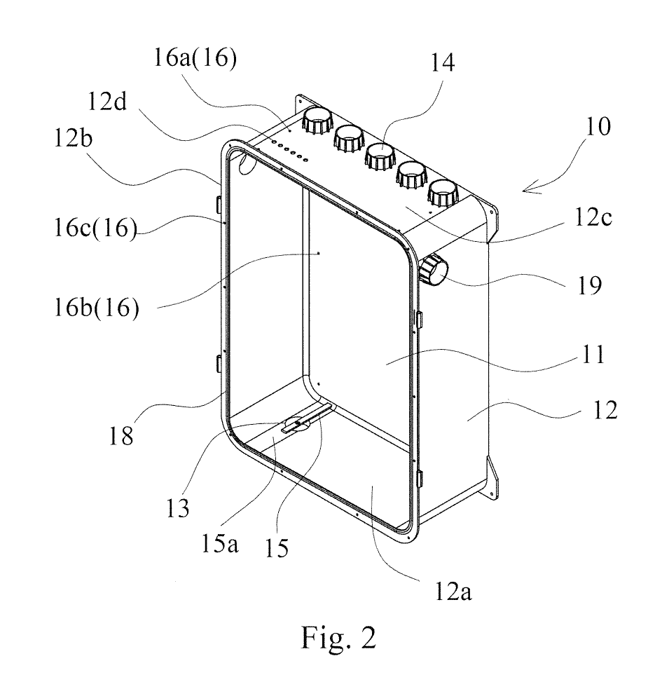

The valve manifold box not only can convey chemicals but also can inspect leakage of chemicals inside the chamber 10. Referring to FIG. 2, according to one embodiment, there is at least one sensor 15 arranged on the inside surface at the bottom sidewall 12a. To inspect leakage more precisely, two or more sensors 15 also can be arranged thereon (not shown in the figures). Moreover, the chamber 10 which is one piece construction further comprises at least one sensor base 15a on the inside surface at the bottom sidewall 12a (as shown in FIG. 2) for assembling the sensor 15 thereon.

According to one embodiment, to enhance expandability and structural strength of the valve manifold box, the chamber 10 further comprises multiple screw holes 16(including 16a, 16b and 16c), as shown in FIG. 2. These screwing holes 16 are formed with the chamber 10 during injection molding. Positions of the screw holes 16 are not limited. They can be located outside or inside the chamber 10. For example, the front cover 20 can be removably attached to the chamber 10 by screwing the front cover 20 to the screw holes 16c of the chamber 10 and screw holes 16c are on the front sidewall 12b.

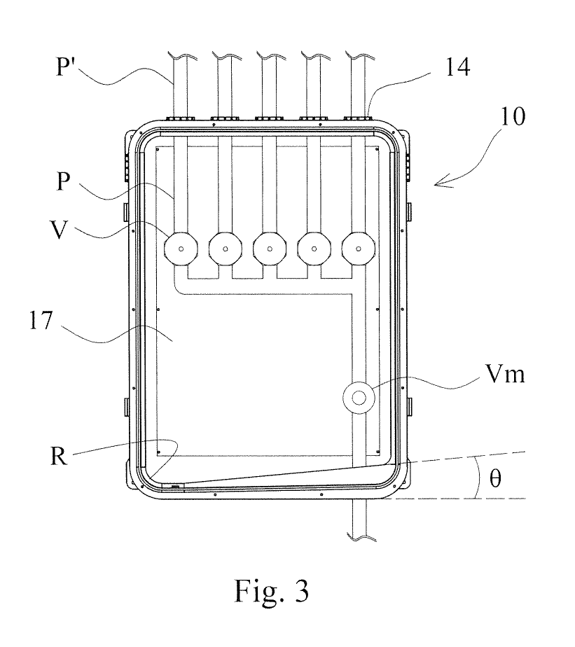

Besides, referring to FIG. 3, the valve manifold box can further comprises a manifold panel 17 arranged inside the chamber 10 by screwing the manifold panel 17 to the screw holes 16b of the chamber 10 and screw holes 16b are located on the back board 11 (as shown in FIG. 2). The manifold panel 17 comprises the pneumatic valves V and the pipelines P inside the chamber 10 arranged thereon.

Referring to FIG. 2 and FIG. 4, in one embodiment, a junction box 30 also can be attached on the chamber 10 by screwing the junction box 30 to the screw holes 16a of the chamber 10. In some case, the junction box 30 is located on the chamber 10 and screwing holes 16a are located on the top sidewall 12c. The junction box 30 comprises multiple solenoid valves (not shown in the figures) which connects a gas source, and connects the pneumatic valves V via multiple air tubes A to control the pneumatic valves V. The air tubes A pass through multiple through holes 12d (as shown in FIG. 2) on the sidewall 12 to connect the pneumatic valves V inside the chamber 10. By controlling the pneumatic valves V, flow rate of liquid in the pipelines P (as shown in FIG. 1B and FIG. 3) can be controlled. Also referring to FIG. 4B, FIG. 4B is a schematic diagram illustrating the structure of the chamber 10 of the valve manifold box according another embodiment of the present invention. It displays the front cover 20 covering on the chamber 10 to form a removable attachment and the junction box 30 arranged on the top sidewall 12c.

As for the fittings 14, types, positions and the number thereof are not restricted. For example, there can be nine fittings on the sidewall 12 and five of them are located on the top sidewall 12c. In one embodiment, the fittings can be FNPT thread.

Sealing performance is a serious concern regarding of the valve manifold box. Therefore, O-ring design for sealing can be used. In one embodiment, an O-ring groove 18 is formed on the front sidewall 12b for accommodating an O-ring inside, as shown in FIG. 2. By this way, it obtains better sealing performance while the front cover 20 is covering the chamber 10 (as shown in FIG. 4).

In respect of materials used in the valve manifold box, in one embodiment, the chamber 10 is made of polypropylene. In another embodiment, the front cover 20 is made of clear polypropylene and is one-piece construction manufactured by injection molding. Hence, users can look through the valve manifold box to ensure operational situations inside. The chamber 10 and the front cover 20 are made of non-metal materials and they cannot be etched by chemicals. Therefore, metal contamination to the valve manifold box can be prevented.

Regarding industrial safety, although the liquid adhering to the chamber 10 inside can be drawn off through the outfall 13, there can be liquid remained inside and generating chemical vapor. It pollutes the workplace and leads to potential risk of explosion; health of staff is also affected. To solve the problem, as shown in the FIG. 1A and FIG. 2, the chamber 10 further comprises at least a vent 19 for discharging exhaust (e.g. chemical vapor) from the chamber 10. Preferably, the vent 19 can be arranged on two sides of the sidewall 12. Additionally, the vent 19 may have the same type of thread with the fittings 14, for example, FNPT threads.

In conclusion, the valve manifold box according to the present invention has several advantages. By means of injection molding, one piece construction of the chamber is obtained such that it prevents chemicals from leaking outside. Besides, by using the design that the inside surface at the bottom sidewall has changes in an inclination angle, liquid can be easily collected and drained. As a result, contamination to equipments and workplace are prevented and industrial safety is maintained. Moreover, since it is unnecessary to frequently maintain the valve manifold box, maintenance costs are saved.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A valve manifold box comprising:
a chamber which is manufactured by injection molding and is one-piece construction, wherein the chamber comprises:
a back board;
a sidewall erecting from the back board to form a space therein and a front opening opposite to the back board, wherein the space is used for accommodating multiple pneumatic valves and multiple pipelines inside the chamber, and an inside surface at the bottom sidewall has changes in an inclination angle for collecting the liquid within the chamber;
at least an outfall arranged on the bottom sidewall for drawing off the collected liquid; and
multiple fittings arranged on the sidewall of the chamber for connecting the pipelines outside the chamber; and
a front cover, which is removably attached to the chamber by covering the front opening of the chamber.

2. The valve manifold box according to claim 1, wherein the chamber is rectangular cuboid in shape with at least one rounded corner or one chamfer corner at corners inside the chamber to makes the liquid adhering to the chamber flow downward along the rounded corner or the chamfer corner.

3. The valve manifold box according to claim 1, wherein the inside surface at the bottom sidewall is inclined or curved with changes in the inclination angle ranging from 0 to 15 degrees.

4. The valve manifold box according to claim 1, wherein the front cover is removably attached to the chamber by using quick release devices.

5. The valve manifold box according to claim 1, wherein the front cover can be partly opened or can be removed.

6. The valve manifold box according to claim 1, wherein the front cover has a curved surface facing the back board to make the liquid adhering to the curved surface slip down.

7. The valve manifold box according to claim 1, wherein at least one sensor is arranged on the inside surface at the bottom sidewall for inspecting leakage inside the chamber.

8. The valve manifold box according to claim 7, wherein the chamber further comprises at least one sensor base on the inside surface at the bottom sidewall for assembling the sensor thereon.

9. The valve manifold box according to claim 1, wherein the chamber further comprises multiple screw holes arranged thereon.

10. The valve manifold box according to claim 9, wherein the front cover is removably attached to the chamber by screwing the front cover to the screw holes of the chamber and screw holes are located on the front sidewall.

11. The valve manifold box according to claim 9 further comprising a manifold panel arranged inside the chamber by screwing the manifold panel to the screw holes of the chamber, wherein the pneumatic valves and the pipelines inside the chamber are arranged on the manifold panel and the screw holes are located on the back board.

12. The valve manifold box according to claim 9 further comprising a junction box attached to the chamber by screwing the junction box to the screw holes of the chamber and the screw holes are on the sidewall, wherein the junction box comprises:
multiple solenoid valves connecting a gas source, and connecting the pneumatic valves via multiple air tubes to control the pneumatic valves, wherein the air tubes pass through multiple through holes on the sidewall to connect the pneumatic valves inside the chamber.

13. The valve manifold box according to claim 1, wherein the chamber is made of polypropylene.

14. The valve manifold box according to claim 1, wherein the front cover is made of clear polypropylene and is one-piece construction manufactured by injection molding.

15. The valve manifold box according to claim 1, wherein an O-ring groove is formed on the front sidewall for accommodating an O-ring inside.

16. The valve manifold box according to claim 1, wherein the chamber further comprises at least a vent for discharging exhaust from the chamber.
